(19) United States
(12) Patent Application Publication
(10) Pub. No.: US 2020/0271628 A1
(43) Pub. Date: Aug. 27, 2020

(54) ABSORBANCE DETECTOR AND CHROMATOGRAPH PROVIDED WITH SAME

(71) Applicant: Shimadzu Corporation, Kyoto (JP)

(72) Inventor: Takafumi NAKAMURA, Kyoto (JP)

(73) Assignee: Shimadzu Corporation, Kyoto (JP)

(21) Appl. No.: 16/067,940

(22) PCT Filed: Apr. 25, 2016
(86) PCT No.: PCT/JP2016/062877

§ 371 Date: Jul. 3, 2018

(30) Foreign Application Priority Data
Mar. 1, 2016 (JP) 2016-038840

(51) Int. Cl. G01N 30/02; G01N 21/01; G01N 21/33

(52) U.S. Cl. CPC G01N 30/02; G01N 2030/027; G01N 21/33; G01N 21/01

(57) ABSTRACT

An absorbance detector and a chromatograph with which it is possible to constantly obtain a maximum quantity of light without suppressing a drive current, even when disposed within a column oven. The disclosure includes a light-emitting unit having LED elements; a light-receiving unit having a photodiode; an absorbance detector cell comprising a cell in which a specimen is accommodated, the absorbance detector cell being disposed between the light-emitting unit and the light-receiving unit; an LED control unit for outputting a drive current to the LED elements; and a temperature sensor for detecting the surrounding temperature around the LED elements.

### FIELD

The present invention relates to a chromatograph including an absorbance detector.

### BACKGROUND

The absorption spectrophotometry is also used in official methods for quantifying a large number of substances and is adopted in various fields as a highly versatile measurement method. In order to carry out the measurement based on such absorption spectrophotometry, it is necessary to have an absorbance detector for detecting an extent of light absorption, in other words, absorbance by a sample to be measured.

The absorbance detector includes a light emitting unit, a light receiving unit and a cell unit that accommodates a sample, and the cell unit is provided on a measurement light path between the light emitting unit and the light receiving unit. Although a type of the light emitting unit changes depending on a wavelength to be measured, a tungsten lamp or a halogen lamp is used as the light emitting unit when a wavelength in a visible light region is measured. A light from this light source is spectrally separated by a diffraction grating (grating) and a light of a certain wavelength is applied to the cell unit that accommodates the sample. The light transmitting through the sample is detected by the light receiving unit using a photodiode or a photomultiplier, and the absorbance is calculated from a transmittance of the light.

In addition, in the case of a simple dedicated detector for measuring a specific substance, there is no need to change a wavelength of light, so that an absorbance detector using a high luminance light emitting diode (LED element) as the light emitting unit is used (see, for example, Patent Document 1). However, when it is desired to perform measurement using a plurality of wavelengths, it is necessary to install a plurality of LED elements having different wavelengths.

FIG. 3 is a diagram illustrating an example of an absorbance detector including two LED elements having different wavelengths. An absorbance detector 130 includes an absorbance detector cell 120, a detector control unit 131 including an LED control unit 131a and a photodiode control unit 31b, an amplification unit 32, and an A/D converter 33.

The absorbance detector cell 120 includes a light emitting unit 121 including two LED elements 121a and 121b and a light emitting photodiode 21c, a light receiving unit 22 including a light receiving photodiode 22a, and a flow cell (a cell unit) 23 which is disposed between the light emitting unit 121 and the light receiving unit 22 and through which a sample passes. An inlet end of the flow cell 23 is connected to an outlet end of a column of chromatograph, and an outlet end of the flow cell 23 is connected to a drain.

The LED elements 121a and 121b are turned on/off and the amount of light emission thereof is controlled according to drive current supplied from the LED control unit 131a, thereby emitting light to the light emitting photodiode 21c and the flow cell 23. Then, the light receiving photodiode 22a detects the light transmitted through the flow cell 23 and outputs an output current while the light emitting photodiode 21c detects the light not passing through the flow cell 23 and outputs an output current.

The photodiodes 21c and 22a are connected to the amplification unit 32, and the amplification unit 32 converts the output current from the photodiodes 21c and 22a into a voltage. Further, this electric signal is digitally converted by the A/D converter 33 and transmitted to the photodiode control unit 31b.

Patent Document 1: Japanese Utility Model No. 3,036,930

### SUMMARY

Since the absorbance detector cell 120 as described above is not provided with a diffraction grating (grating) or the like and is in a compact and simple form, it is sometimes used while being housed in a thermostat or the like.

Meanwhile, a UVLED element which is a kind of the LED element is vulnerable to heat, and may be damaged when a temperature of a junction portion reaches around 85° C. For example, when a value I of a drive current is 100 mA for a UVLED element having a thermal resistance of 45° C./W and a forward voltage value of 10 V, a power consumption value of the UVLED element is 1 W and rises by 45° C. from an ambient temperature t. Therefore, although it can withstand if the ambient temperature t is 20° C., it will be damaged if it is used in a column oven where an inside temperature may become 50° C.

Therefore, when the absorbance detector cell is disposed in the column oven, if an environmental temperature t under which the absorbance detector cell can be installed is regulated to be 60° C., an allowable rising temperature due to heat generation of the UVLED element itself is 25° C. Thus, an upper limit value I_{UP} of the drive current can be set only to about 55.6 mA. However, all users do not set an inside of the column oven to be 60° C. and, in this case, a noise becomes about 1.4 times the noise in a case where the value I of the drive current is 100 mA.

Therefore, the present invention intends to provide an absorbance detector capable of always obtaining a maximum amount of light without sparingly supplying a driving current even when placed in a column oven, and a chromatograph including the absorbance detector.

A chromatograph of the present invention made to solve the above-mentioned problem includes: a column oven including an oven, a column disposed inside the oven, a first temperature sensor that detects an inside temperature of the oven, and a heater that heats air in the oven based on the inside temperature of the oven detected by the first temperature sensor; and an absorbance detector cell disposed inside the oven, wherein the absorbance detector cell includes a light emitting unit including an LED element, a light receiving unit, a cell unit that is disposed between the light emitting unit and the light receiving unit and accommodates a sample, and a second temperature sensor that detects an ambient temperature of the LED element in a housing of the absorbance detector, and wherein the chromatograph further includes an LED control unit that outputs a drive current to the LED element and determines an upper limit value of the drive current to be output to the LED element based on the temperature detected by the second temperature sensor.

According to a chromatograph of the present invention, a temperature sensor is provided in a light emitting unit of an absorbance detector cell to monitor an ambient temperature t of the light emitting unit, and an upper limit value I_{UP} of a driving current is changed according to an obtained ambient temperature t. Therefore, the drive current at its upper limit value is supplied according to the ambient temperature t instead of being supplied sparingly, whereby a maximum amount of light can always be obtained. Thus, it is possible to minimize a noise based on the temperature and measure with ultra-high sensitivity.

Further, in the chromatograph of the present invention, the LED control unit may always calculate the upper limit value of the drive current to be output to the LED element based on the ambient temperature detected by the temperature sensor and thermal resistance of the LED element.

Further, in the chromatograph of the present invention, the LED control unit may determine the upper limit value of the drive current to be output to the LED element based on the temperature detected by the second temperature sensor after determining that the inside temperature of the oven detected by the first temperature sensor is stable.

Then, in the chromatograph of the present invention, a table where the temperature measured by the second temperature sensor associated with the upper limit value of the drive current to be output to the LED element may be stored, and the LED control unit may use the table to determine the upper limit value of the drive current to be output to the LED element.

### BRIEF DESCRIPTION OF THE DRAWINGS

FIG. 1 is a schematic configuration diagram illustrating an example of a liquid chromatograph where the present invention is applied.

FIG. 2 is a diagram illustrating an absorbance detector in FIG. 1.

FIG. 3 is a diagram illustrating an example of an absorbance detector using a conventional LED.

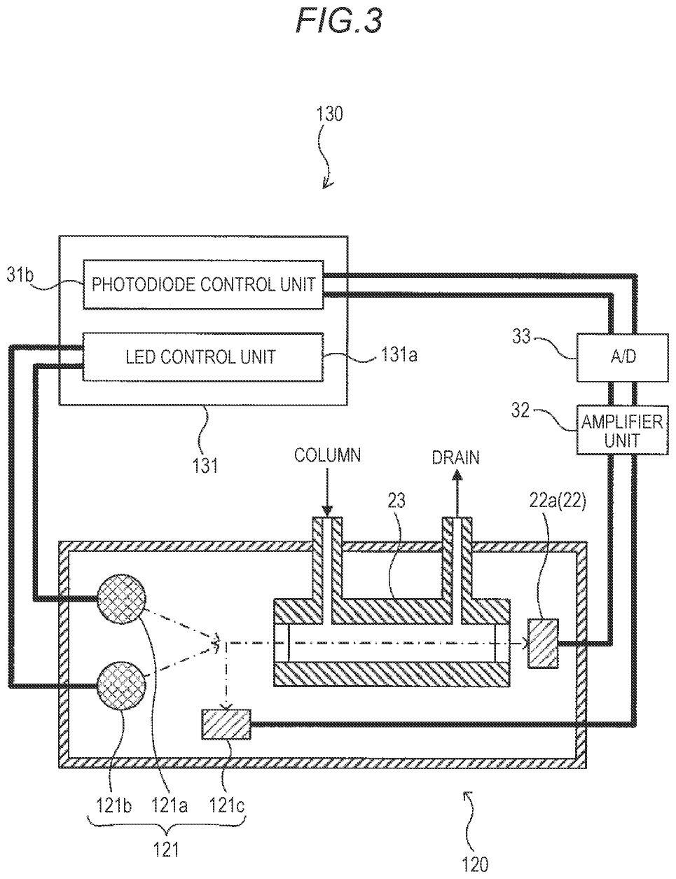

### DETAILED DESCRIPTION OF THE DRAWINGS

Hereinafter, embodiments of the present invention will be described with reference to the drawings. It should be noted that the present invention is not limited to the embodiments described below, and it goes without saying that various embodiments are included within a scope not deviating from the gist of the present invention.

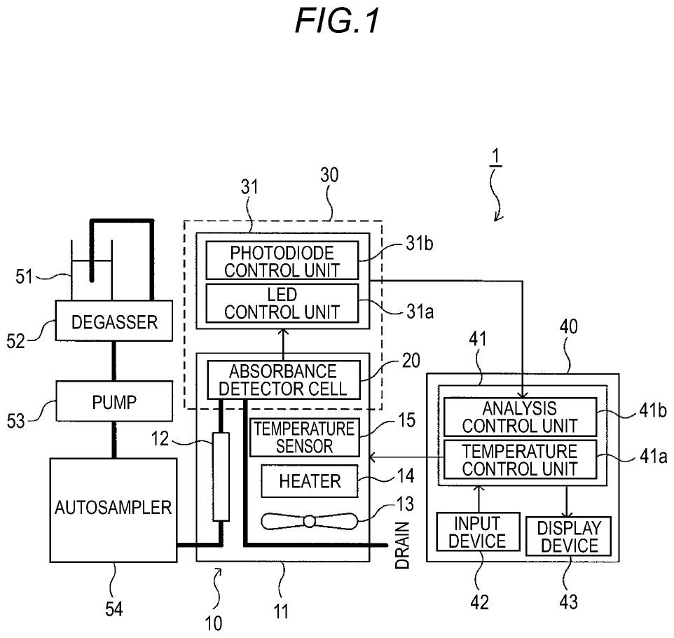

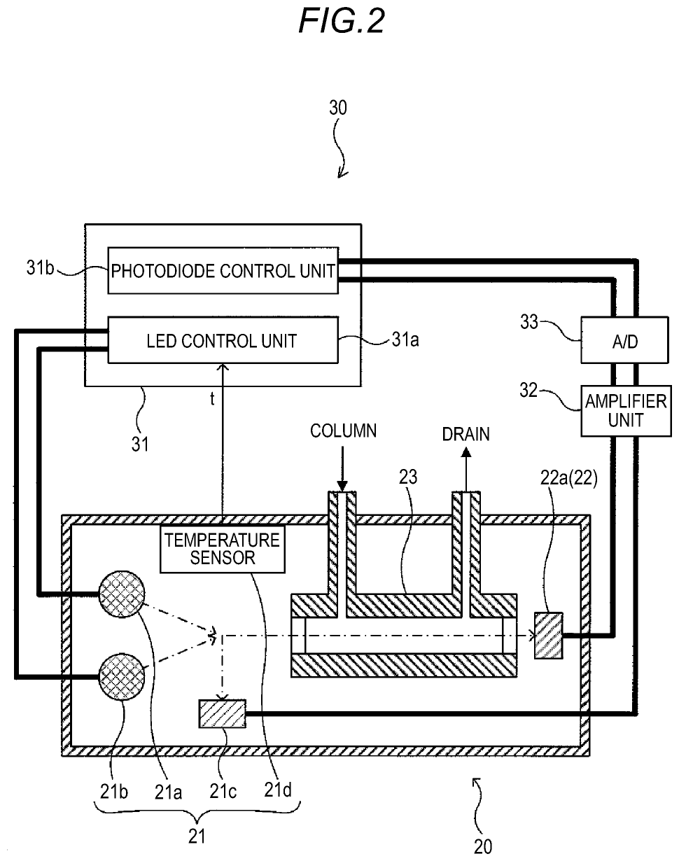

FIG. 1 is a schematic configuration diagram illustrating an example in a case where an absorbance detector according to the present invention is applied to a liquid chromatograph, and FIG. 2 is a view illustrating a configuration of the absorbance detector in FIG. 1. Note that the same reference numerals are given to the same components as those of the above-described absorbance detector 130, and the description thereof will be omitted.

Liquid chromatograph 1 includes a container 51 where a moving phase is accommodated, a degasser 52 connected to the container 51, a pump 53 connected to the degasser 52, an autosampler 54 which is provided to a flow path connected to the pump 53 and into which a sample is introduced, a column oven 10 including a column 12 connected to the autosampler 54, an absorbance detector 30 including an absorbance detector cell 20 connected to the column 12, and a computer 40.

The column oven 10 includes a rectangular parallelepiped oven 11. Inside the oven 11, the column 12 through which a sample passes, a fan 13 that circulates air, a heater 14 that heats the air, and a temperature sensor 15 that detects an oven temperature t′ inside the oven 11 are accommodated.

The computer 40 includes a CPU 41, and an input device 42 including a keyboard, a mouse and the like, and a display device 43 are connected thereto. In addition, when functions to be processed by the CPU 41 is described in a block form, the CPU 41 includes a temperature control unit 41a that controls the column oven 10 and the like and an analysis control unit 41b that receives an electric signal from a detector control unit 31 of the absorbance detector 30.

The temperature control unit 41a performs a control of supplying a driving current to the heater 14 based on the oven temperature t′ detected by the oven temperature sensor 15 by the user using the input device 42 to set the “oven temperature (for example, 35° C),” thereby adjusting the oven temperature t′ to be the set oven temperature. In addition, the temperature control unit 41a performs a control to determine whether or not the oven temperature t′ has stabilized at the set oven temperature at the time of performing a measurement.

The analysis control unit 41b controls to execute various operation processing based on the electric signal acquired by a photodiode control unit 31b of the absorbance detector 30 and display a result of the operation on the display device 43.

The absorbance detector 30 includes the absorbance detector cell 20 arranged in the oven 11, the detector control unit 31 arranged outside the oven 11 and connected to the computer 40, an amplification unit 32 and an A/D converter 33.

The absorbance detector cell 20 includes a light emitting unit 21 including two UVLED elements 21a and 21b, a light emitting photodiode 21c and a temperature sensor 21d that detects an ambient temperature t of the UVLED elements 21a and 21b, a light receiving unit 22 including a light receiving photodiode 22a, and a flow cell (cell unit) 23 which is disposed between the light emitting unit 21 and the light receiving unit 22 and through which a sample passes. Then, an inlet end of the flow cell 23 is connected to an outlet end of the column 12 of the chromatograph, and an outlet end of the flow cell 23 is connected to a drain.

The detector control unit 31 includes an LED control unit 31a that supplies the drive current to the UVLED elements 21a and 21b and acquires the ambient temperature t from the LED element temperature sensor 21d, and the photodiode control unit 31b that acquires the electrical signal from the photodiodes 21c and 22a via the amplification unit 32 and the A/D converter 33.

As the drive current is supplied from the LED control unit 31a, the UVLED elements 21a and 21b are turned on/off and its amount of light emission are controlled, thereby emitting light to the light emitting photodiode 21c and the flow cell 23.

The LED element temperature sensor 21d detects the ambient temperature t of the UVLED elements 21a and 21b and outputs the same to the LED control unit 31a.

After it is determined by the temperature control unit 41a that the oven temperature t′ has been stabilized at a set temperature, the LED control unit 31a performs a control to calculate an upper limit value I_{UP} of the drive current to be output to the UVLED elements 21a and 21b to determine a value I of the drive current, based on the ambient temperature t and a thermal resistance (for example, 45° C./W) of the UVLED elements 21a and 21b. For example, when the ambient temperature t is 35° C., the LED control unit 31a calculates that an allowable rising temperature of the UVLED elements 21a and 21b themselves is 50° C., and the upper limit value I_{UP} of the driving current is calculated as being 111 mA. Next, the LED control unit 31a outputs the value I of the drive current of 90 mA provided with a certain margin for preventing a failure, to the UVLED elements 21a and 21b.

As described above, according to the liquid chromatograph 1 of the present invention, the maximum amount of light can always be obtained by supplying the drive current at its upper limit value corresponding to the ambient temperature t, instead of supplying the drive current sparingly. Thus, it is possible to minimize the noise based on the temperature, to perform a measurement with ultra-high sensitivity, and to reduce the piping capacity and perform the measurement with highly sensitivity.

(1) In the liquid chromatograph 1 described above, the LED control unit 31a is configured to calculate the upper limit value I_{UP} of the drive current based on the ambient temperature t and the thermal resistance (for example, 45° C./W) of the UVLED elements 21a and 21b, but, alternatively, may be configured to calculate the upper limit value I_{UP} of the drive current using a “table of the ambient temperature t—the upper limit value I_{UP} of the drive current.”

(2) In the liquid chromatograph 1 described above, the LED control unit 31a is configured to calculate the upper limit value I_{UP} of the drive current after it is determined by the temperature control unit 41a that the oven temperature t′ has been stabilized at the set temperature, but, alternatively, may be configured to calculate the upper limit value I_{UP} of the drive current only when the user inputs “execute the function of calculating the upper limit value I_{UP} of the drive current.” That is, ON/OFF of the function may be set.

The present invention can be applied to, for example, a chromatograph including an absorbance detector.

1-4. (canceled)

5. A chromatograph, comprising:
a column oven including an oven, a column disposed inside the oven, a first temperature sensor that detects an inside temperature of the oven, and a heater that heats air in the oven based on the inside temperature of the oven detected by the first temperature sensor; and
an absorbance detector cell disposed inside the oven,
wherein the absorbance detector cell includes a light emitter including an LED element, a light receiver, a cell that is disposed between the light emitter and the light receiver and accommodates a sample, and a second temperature sensor that detects an ambient temperature of the LED element in a housing of the absorbance detector, and
wherein the chromatograph further comprises an LED controller that outputs a drive current to the LED element and determines an upper limit value of the drive current to be output to the LED element based on the temperature detected by the second temperature sensor.

6. The chromatograph according to claim 5, wherein the LED controller calculates the upper limit value of the drive current to be output to the LED element based on the ambient temperature detected by the second temperature sensor and thermal resistance of the LED element.

7. The chromatograph according to claim 5, wherein the LED controller determines the upper limit value of the drive current to be output to the LED element based on the temperature detected by the second temperature sensor after determining that the inside temperature of the oven detected by the first temperature sensor is stable.

8. The chromatograph according to claim 5,
wherein a table where the temperature measured by the second temperature sensor associated with the upper limit value of the drive current to be output to the LED element is stored, and
wherein the LED controller uses the table to determine the upper limit value of the drive current to be output to the LED element.
